(19) United States
(12) Patent Application Publication
(10) Pub. No.: US 2019/0030383 A1
(43) Pub. Date: Jan. 31, 2019

(54) FOAM DELIVERY SYSTEM

(71) Applicant: Richard Bovensiep, Troy, MI (US)

(72) Inventor: Richard Bovensiep, Troy, MI (US)

(21) Appl. No.: 16/048,014

(22) Filed: Jul. 27, 2018

Related U.S. Application Data
(60) Provisional application No. 62/538,572, filed on Jul. 28, 2017.

(51) Int. Cl. A62C 31/12; A62C 5/02; B05B 7/00

(52) U.S. Cl. CPC A62C 31/12; B05B 7/005; A62C 5/02

(57) ABSTRACT

A stillwell/siphon system may be attached or integrated into a foam delivery bucket. When pouring foam additive into the bucket, foam/bubbles may form in the foam additive. The stillwell may fill from the bottom to prevent the foam/bubbles from getting inside the stillwell tube so one can easily ascertain the level of foam in the container. The stillwell also blocks air pockets, formed from pouring foam into the container, from entering the outlet tube, which is positioned inside the stillwell.

### CROSS-REFERENCE TO RELATED APPLICATIONS

This application claims the benefit of priority to U.S. provisional patent application No. 62/538,572, filed Jul. 28, 2018, the contents of which are herein incorporated by reference.

### BACKGROUND OF THE INVENTION

### 1. Field of the Invention

Embodiments of the invention relates generally to fluid transfer devices. More particularly, the invention relates to an apparatus for transferring foaming liquids from one container to another container, where the second container includes a suction connection for removing the foaming liquid therefrom. Embodiments of the present invention relate to such devices for transferring firefighting foam.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

During foam operations, firefighters often use an eductor that withdraws foam from a container at a given rate by the venturi principle. The foam is usually carried in containers, such as five-gallon container that are poured into a larger barrel, where it is then sucked into the water stream.

However, by transferring this foam into this larger barrel, problems may occur. For example, air pockets may be formed during pouring that could get inside the suction tube which may break the suction or alter the foam concentration in the water stream. Additionally, if suds build up on the larger bucket, one cannot easily determine when the level of foam concentrate is getting low.

In view of the foregoing, there is a need for an improved apparatus for removing a liquid from a container, especially a foaming liquid, such a firefighting foam concentrate.

### SUMMARY OF THE INVENTION

Embodiments of the present invention provide a stillwell/siphon system comprising an outer tube having a top end and a bottom end; an inner tube disposed inside the outer tube, the inner tube having a first end adjacent a bottom end of the outer tube and a second end extending outside the outer tube; and a connector disposed on the second end of the inner tube.

Embodiments of the present invention further provide a fluid delivery system comprising a stillwell/siphon system including an outer tube having a top end and a bottom end, an inner tube disposed inside the outer tube, the inner tube having a first end adjacent a bottom end of the outer tube and a second end extending outside the outer tube, and a connector disposed on the second end of the inner tube; and a container having the stillwell/siphon disposed therein, the container operable to receive a fluid for delivery out through the connector.

Embodiments of the present further provide a firefighting foam delivery system comprising a stillwell/siphon system including an outer tube having a top end and a bottom end, an inner tube disposed inside the outer tube, the inner tube having a first end adjacent a bottom end of the outer tube and a second end extending outside the outer tube, the second end of the inner tube bends to extend through a portion of the outer tube near the top end thereof, and a connector disposed on the second end of the inner tube; and a container having the stillwell/siphon disposed therein, the container operable to receive firefighting foam for delivery out through the connector.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a perspective view of a container having a stand-alone stillwell/siphon system removably attached thereto according to an exemplary embodiment of the present invention;

FIG. 2 illustrates a cross-sectional view of the stand-alone stillwell/siphon system of FIG. 1;

FIG. 3 illustrates a perspective view of a container having an integrated stillwell/siphon system fixed thereto according to an exemplary embodiment of the present invention;

FIG. 4 illustrates a cross-sectional view of the integrated stillwell/siphon system of FIG. 2;

FIGS. 5A through 5C illustrate a plurality of sizes of integrated stillwell/siphon systems that may be used in different sized containers;

FIGS. 5D and 5E illustrate two sizes of integrated stillwell/siphon systems according to exemplary embodiments of the present invention;

FIG. 5F illustrates an elongated inner tube member usable in embodiments of the present invention; and

FIGS. 6A and 6B illustrate back perspective views of the two different sized integrated stillwell/siphon systems of FIGS. 5D and 5E.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a stillwell/siphon system that may be attached or integrated into a foam delivery bucket. The stillwell stops the foam from getting inside tube so one can easily ascertain the level of foam in the container. The stillwell also blocks air pockets, formed from pouring foam into the container, from entering the outlet tube, which is positioned inside the stillwell.

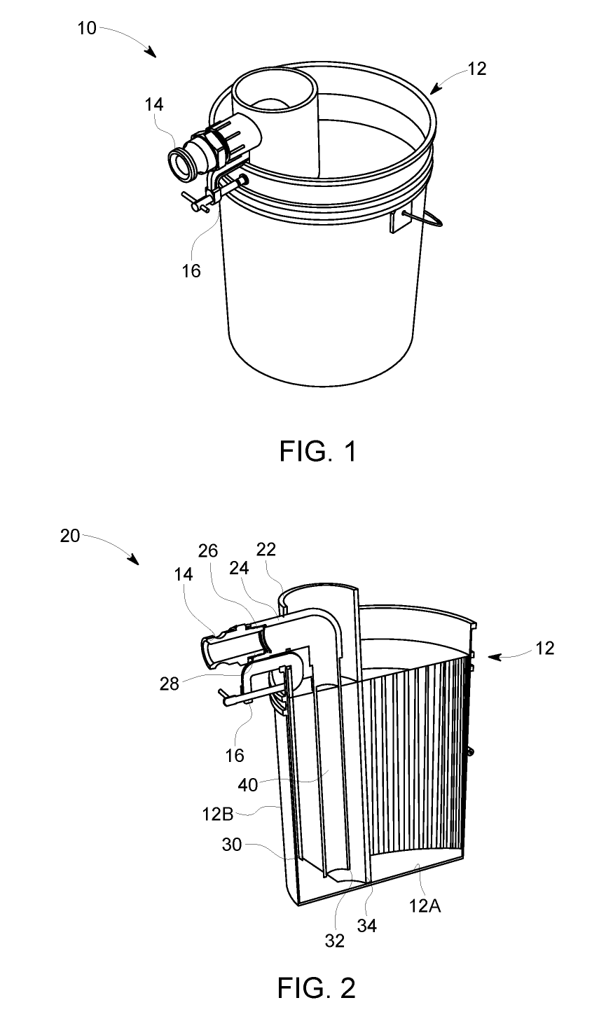

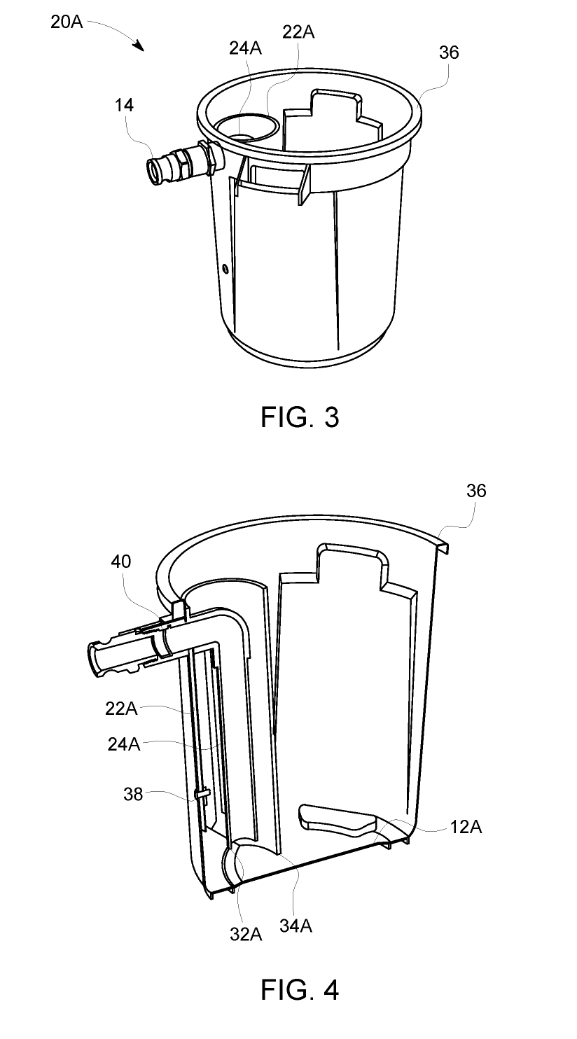

Referring to FIGS. 1 and 2, a foam delivery system 10 can include a container 12 for receiving a liquid 40, such as a foaming liquid, including, for example, firefighting foam concentrate. A stillwell/siphon system 20 may be removable attached thereto. As best seen in FIG. 2, the stillwell/siphon system 20 can include an outer tube 22, forming the stillwell, surrounding an inner tube 24, which is an outlet tube 26 from the container 12. The outlet tube 26 may come out at an angle, such as a 90-degree angle, from the outer tube 24 forming the stillwell.

A clamp 16 may extend from the outer surface of the outer tube 22 to permit the assembly to be clamped onto the container 12. Various types of clamps, as are known in the art, may be used. In some embodiments, a hanger (not shown) may extend from the outer surface of the outer tube 22 to permit the assembly to simply hang inside the container 12 from its outer edge.

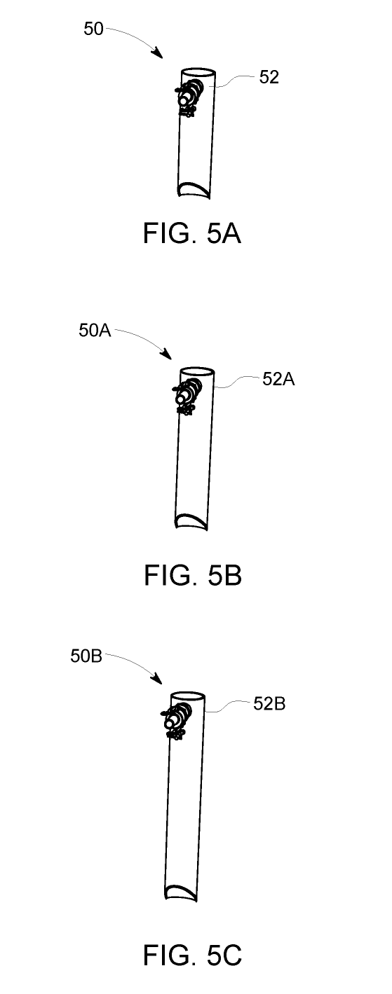

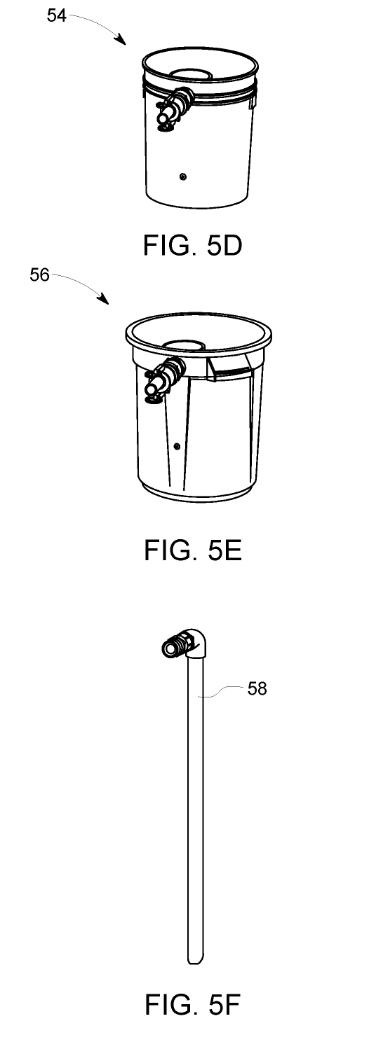

In some embodiments, the inner tube 24 may have an end portion 32 that can terminate prior to the terminus 34 of the outer tube 22 that forms the stillwell. This can help prevent flow restriction caused by the inner tube 24 resting flat on the bottom 12A of the container 12. In some embodiments, the bottom edge 34 of the outer tube 22 may be formed in a curved shape 30 (as best seen in FIG. 5, for example) to prevent the outer tube 22 from resting flush on the bottom 12A of the container 12, thereby permitting free flow of fluid from the container 12 into the stillwell formed inside the outer tube 22.

Referring now to FIGS. 4 through 6, in some embodiments, the clamp 16 may be eliminated and the stillwell/siphon system 20A may be formed integrally with the container 36 by having the inner tube 24A, after making the angled turn (after, for example, the 90 degree turn in the inner tube 24A), exit through an opening in the container 36. In this embodiment, the other features described above with respect to FIGS. 1 and 2 may be similar. However, in this embodiment, the end 34A of the outer tube 22A (the tube forming the stillwell) does not need to be curved or flared because the length of the outer tube 22A may be specifically designed for the particular container for which it is integrally formed, thus, the distance from the end 34A of the outer tube 34A and the bottom 12A of the container 36 is fixed.

In some embodiments, the fitting, such as a bulkhead fitting 40, may be used to secure the outlet tube to an opening or hole in the side of the container. In this embodiment, a user may unscrew the bulkhead fitting 40 to remove the stillwell/siphon system 20A from the container 36. In other embodiments, the inner tube 24A may be permanently fixed to the container 36.

In some embodiments, a connector 38, such as a screw, bolt and nut, or the like, may be used to secure the outer tube 22A to the side of the container 36. Other connection means may be used, including adhesives, clamps, or the like.

FIGS. 5A through 5C show various lengths to provide a system 50, 50A, 50B according to embodiments of the present invention. The various sizes for the system may be used in various sized containers, such as containers 54, 56 shown in FIGS. 5D and 5E. FIG. 5F shows an extended length of an inner tube 58 that may be useful in certain embodiments of the present invention.

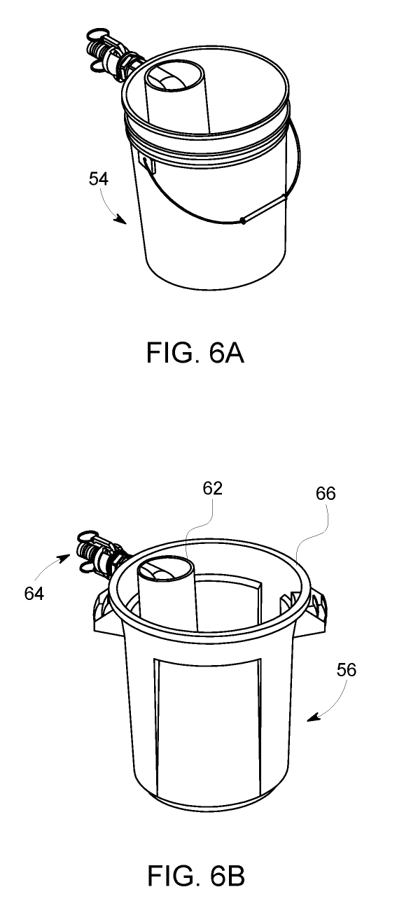

Referring to FIGS. 6A and 6B, the containers 54, 56 of FIGS. 5D and 5E are shown in further detail. In some embodiments, a top end 62 of the outer tube may terminate below a top 66 of the container 54, 56. Such a configuration allows a lid to be placed on the container 54, 56. Various connectors may be provided, depending on the specific application, to fluidly connect the inner tube to its outlet. One such connector 64 is illustrated in FIG. 6B.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A stillwell/siphon system comprising:
an outer tube having a top end and a bottom end;
an inner tube disposed inside the outer tube, the inner tube having a first end adjacent a bottom end of the outer tube and a second end extending outside the outer tube; and
a connector disposed on the second end of the inner tube.

2. The stillwell/siphon system of claim 1, wherein the second end of the inner tube bends to extend through a portion of the outer tube near the top end thereof.

3. The stillwell/siphon system of claim 2, wherein the inner tube bends about 90 degrees to extend through the portion of the outer tube.

4. The stillwell/siphon system of claim 1, wherein the second end of the inner tube terminates prior to reaching a bottom end of the outer tube.

5. The stillwell/siphon system of claim 1, wherein the bottom end of the outer tube is formed an angle relative to a plane orthogonal to a longitudinal axis of the outer tube.

6. A fluid delivery system comprising:
a stillwell/siphon system including:
an outer tube having a top end and a bottom end;
an inner tube disposed inside the outer tube, the inner tube having a first end adjacent a bottom end of the outer tube and a second end extending outside the outer tube; and
a connector disposed on the second end of the inner tube; and
a container having the stillwell/siphon disposed therein, the container operable to receive a fluid for delivery out through the connector.

7. The fluid delivery system of claim 6, wherein the second end of the inner tube bends to extend through a portion of the outer tube near the top end thereof.

8. The fluid delivery system of claim 7, wherein the inner tube bends about 90 degrees to extend through the portion of the outer tube.

9. The fluid delivery system of claim 6, wherein the second end of the inner tube terminates prior to reaching a bottom end of the outer tube.

10. The fluid delivery system of claim 6, wherein the bottom end of the outer tube is formed an angle relative to a bottom surface of the container.

11. The fluid delivery system of claim 6, wherein the stillwell/siphon system is clamped onto the container.

12. The fluid delivery system of claim 11, wherein the inner tube extends over a top end of the container.

13. The fluid delivery system of claim 6, wherein the stillwell/siphon system is formed integrally with the container.

14. The fluid delivery system of claim 13, wherein the inner tube extends through an opening formed in the container.

15. The fluid delivery system of claim 14, wherein a bulkhead fitting is disposed in the opening through which the inner tube passes.

16. The fluid delivery system of claim 6, wherein the fluid is firefighting foam.

17. A firefighting foam delivery system comprising:
a stillwell/siphon system including:
an outer tube having a top end and a bottom end;
an inner tube disposed inside the outer tube, the inner tube having a first end adjacent a bottom end of the outer tube and a second end extending outside the outer tube, the second end of the inner tube bends to extend through a portion of the outer tube near the top end thereof; and
a connector disposed on the second end of the inner tube; and
a container having the stillwell/siphon disposed therein, the container operable to receive firefighting foam for delivery out through the connector.

18. The firefighting foam delivery system of claim 17, wherein the stillwell/siphon system is clamped onto the container and the inner tube extends over a top end of the container.

19. The firefighting foam delivery system of claim 17, wherein the stillwell/siphon system is formed integrally with the container.
